(19) United States
(12) Patent Application Publication
(10) Pub. No.: US 2024/0235968 A9
(43) Pub. Date: Jul. 11, 2024

(54) METHOD AND APPARATUS FOR LOGGING EVENTS IN COMMUNICATION NETWORKS

(71) Applicant: Samsung Electronics Co., Ltd., Suwon-si (KR)

(72) Inventors: Deepanshu GAUTAM, Bangalore (IN); Ashutosh KAUSHIK, Bangalore (IN)

(21) Appl. No.: 18/491,537

(22) Filed: Oct. 20, 2023

(30) Foreign Application Priority Data
Oct. 22, 2022 (IN) 202241060605
Aug. 16, 2023 (IN) 202241060605

(51) Int. Cl. H04L 43/04; H04L 43/062

(52) U.S. Cl. CPC H04L 43/04; H04L 43/062

(57) ABSTRACT

A method and an apparatus for logging events in a communication system is provided. The method comprises receiving, from a network function, a request for creating a managed object instance (MOI) of an information object class (IOC) for registering logs associated with a plurality of management services of a communication network. The method further comprises creating a fragment of network resource model (NRM) for logging events associated with the plurality of management services, based on the MOI, wherein the NRM comprises a set of MOIs. Additionally, creating the fragment comprises generating the set MOIs for logging events related to the plurality of management services, wherein the set of MOIs comprise an MOI for registration of a log, an MOI for information of the log, and an MOI for entry of the log. Advantageously, the present disclosure enables logging of events in communication networks.

### CROSS REFERENCE TO RELATED APPLICATIONS

This application is based on and claims priority under 35 U.S.C. § 119 to Indian Provisional Patent Application No. 202241060605, filed on Oct. 22, 2022, and Indian Complete Patent Application No. 202241060605, filed on Aug. 16, 2023, in the Indian Intellectual Property Office, the disclosures of which are incorporated herein by reference.

### BACKGROUND

### 1. Field

The present disclosure generally relates to communication networks. More particularly, the present disclosure relates to a method and an apparatus for logging events in communication networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Over time, communication networks have undergone significant evolution, advancing to accommodate diverse communication services, varying traffic loads, and serving distinct user communities. The concept of network slicing has emerged as a pivotal technology in modern communication networks, enabling creation of virtual networks tailored to meet specific requirements of various communication services. The objective of network slicing is to provide optimized support for a wide range of communication services, such as emerging vehicle-to-everything (V2X) applications that demand seamless enhanced mobile broadband (eMBB) services with stringent key performance indicators (KPIs) including data rate, reliability, latency, communication range, and speed.

To achieve efficient resource utilization and improved service delivery, fixed mobile convergence (FMC) has been introduced within the communication networks. FMC integrates wireless-to-the-everything (WTTx) and fiber-to-the-everything (FTTx) technologies, offering native support for network slicing. This optimization empowers communication networks to dynamically select the most appropriate access technology (3GPP or non-3GPP) for diverse communication services. Moreover, this approach allows networks to simultaneously use multiple access technologies on a single user equipment (UE), enhancing overall resource efficiency.

However, despite these advancements, current communication network management standards have certain shortcomings. While standardized mechanisms facilitate management of network slices and communication service instances (CSI), a critical functionality is lacking. Specifically, there exists no mechanism to control and generate logs for consumed management services, hindering effective network troubleshooting and root cause analysis.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The present disclosure provides a method and an apparatus for logging events efficiently in a communication system.

Various disclosed embodiments include methods for logging events in communication networks. A method comprises receiving, from a network function, a request for creating a managed object instance (MOI) of an information object class (IOC) for registering logs associated with a plurality of management services of a communication network. The method further comprises creating a fragment of a network resource model (NRM) for logging events associated with the plurality of management services, based on the MOI. The NRM comprises a set of MOIs. Herein, creating the fragment comprises generating the set MOIs for logging events related to the plurality of management services. The set of MOIs comprise an MOI for registration of a log, an MOI for information of the log, and an MOI for an entry of the log. Additionally, the set of MOIs indicate a list of categories for the plurality of management services to be logged, and a list of instances for the plurality of management services to be logged.

Various disclosed embodiments include a network entity including a log management network function for logging events in a communication system. A network entity comprises a network interface, and a processor. The processor is configured to receive a request for creating a managed object instance (MOI) of an information object class (IOC) for registering logs associated with a plurality of management services of a communication network, from a network function. Thereafter, the processor is configured to create a fragment of a network resource model (NRM) for logging events associated with the plurality of management services, based on the MOI. The NRM comprises a set of MOIs. Herein, creating the fragment comprises generating the set MOIs for logging the events related to the plurality of management services. The set of MOIs comprise an MOI for registration of a log, an MOI for information of the log, and an MOI for an entry of the log. Additionally, the set of MOIs indicate a list of categories for the plurality of management services to be logged, and a list of instances for the plurality of management services to be logged.

The foregoing summary is illustrative only and is not intended to be in any way limiting. In addition to the illustrative aspects, embodiments, and features described above, further aspects, embodiments, and features will become apparent by reference to the drawings and the following detailed description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The present disclosure, as well as a preferred mode of use, further objectives, and advantages thereof, will best be understood by reference to the following detailed description when read in conjunction with the accompanying figures, wherein like reference numerals represent like elements, and in which:

FIG. 1A and FIG. 1B illustrate environments for logging events in communication networks, in accordance with various embodiments of the present disclosure;

FIG. 2 illustrates a detailed diagram of a log management network function, in accordance with various embodiments of the present disclosure;

FIG. 3A and FIG. 3B illustrate relationships between information object classes (IOCs) of a set of managed object instances (MOIs) for logging events in communication networks, in accordance with an embodiment of the present disclosure;

FIG. 4 illustrates a flow chart of method steps for logging events in communication networks, in accordance with various embodiments of the present disclosure;

FIG. 5 illustrates a sequence diagram of steps for logging events in communication networks, in accordance with various embodiments of the present disclosure; and

FIG. 6 illustrates a block diagram of a computer system for implementing various embodiments of the present disclosure.

It should be appreciated by those skilled in the art that any block diagram herein represents conceptual views of illustrative systems embodying the principles of the present disclosure. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

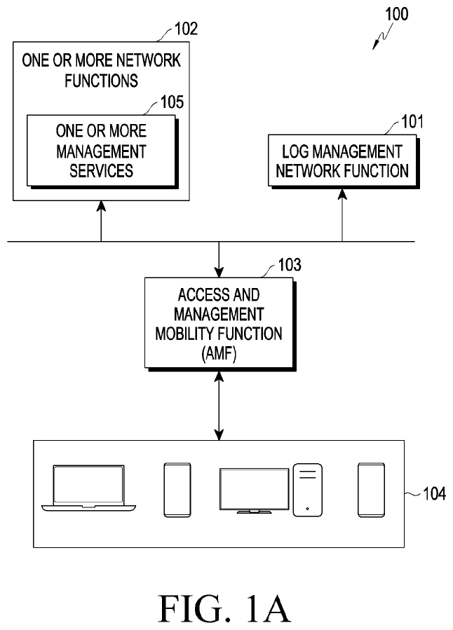

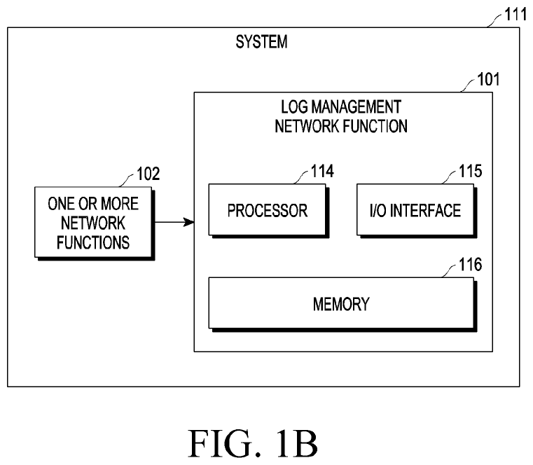

FIGS. 1A through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

While the present disclosure is susceptible to various modifications and alternative forms, specific embodiments thereof have been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises,” “comprising,” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Various disclosed embodiments include a method and a system for logging events in communication networks. In current communication systems (For example, 5th generation new radio (5G NR)), there is no provision for recoding logs of consumed management services. Therefore, to overcome this, the present disclosure creates a network resource model (NRM) fragment specifically for enabling logging functionality in such communication networks. Herein, a request for creating a managed object instance (MOI) of an information object class (IOC) is received from a network function. Thereafter, a fragment of an NRM is created for logging events associated with the plurality of management services, based on the MOI. The NRM comprises a set of MOIs. Herein, the set of IOCs indicate a list of management services to be logged, and a list of instances for the plurality of management services to be logged. Advantageously, the method and system disclosed herein provide effective control and generation of logs for consumed management services associated with the communication network. Moreover, the logging functionality significantly enhances network troubleshooting capabilities, enabling prompt root cause analysis and efficient problem resolution. As a result, the overall network management efficiency improves, ensuring superior service delivery and optimized network performance.

The present disclosure is explained with reference to the figures. However, such embodiments should not be construed as limitations of the present disclosure since the methods as disclosed may be used or employed for any system for logging events in communication networks. A person skilled in the art may envisage various such embodiments without deviating from scope of the present disclosure.

FIG. 1A and FIG. 1B illustrate environments for logging events in communication networks, in accordance with various embodiments of the present disclosure.

Referring specifically to FIG. 1A, an environment 100 for logging events in communication networks, in accordance with various embodiments of the present disclosure, is illustrated.

As shown in FIG. 1A, the environment 100 for logging events in communication networks includes a log management network function 101 and one or more network functions 102. A network function is defined as a hardware component/network entity within a communication network responsible for performing specific tasks. Such tasks may include, without limitation, routing, switching, security, load balancing, quality of service management, or network address translation (NAT). These network functions are fundamental to operations and efficiency of modern communication networks, enabling seamless processing, management, and forwarding of data packets to support diverse communication services and ensure optimal network performance. In a service-based management architecture of the communication network, the one or more network functions 102 either produce or consume a plurality of management services (acting as either a management service consumer or a management service producer). Notably, the log management network function 101 and the one or more network functions 102 are network functions performing various tasks of the communication network. Herein, the log management network function 101 manages logs pertaining to the one or more events related to the one or more management services, and the one or more network functions 102 perform other tasks associated with the communication network. For example, the one or more network functions 102 may be implemented for routing.

Moreover, the environment 100 also includes an access and management mobility function (AMF) 103. The AMF 103 refers to a core network entity which is responsible for managing user access and mobility within the communication network. The AMF 103 is communicably coupled to the log management network function 101, the one or more network functions 102, and one or more user equipment 104. Notably, the AMF 103, the one or more network functions 102, and the log management network function 101 are communicably coupled via a service-based interface. It will be appreciated that the environment 100 may also include other components not shown explicitly herein.

The one or more user equipment 104 refer to devices which may be utilized by a user of the communication network. The one or more user equipment 104 may be implemented as a variety of computing systems, such as, a laptop computer, a desktop computer, a personal computer (PC), a notebook, a smartphone, a tablet, and the like.

The one or more network functions 102 comprise one or more management services 105 (also referred to as a plurality of management services). The term “management services” refers to services which offer capabilities to manage various aspects of the communication network. These management capabilities are accessed by management service consumers via standardized service interface composed of individually specified management service components. Notably, the plurality of management services work in tandem to manage the communication network. For example, the management services may encompass tasks such as network monitoring, configuration, fault management, security management, and performance optimization, catering to the specific requirements of different network components. Advantageously, presence of the plurality of management services ensures comprehensive coverage of network operations, enabling efficient and reliable management, and resolution of network issues, ultimately enhancing the overall performance and functionality of the communication network.

In an embodiment of the present disclosure, the communication network may be implemented as a 5^{th} generation new radio (5G NR) communication network. 5G NR refers to a wireless communication standard that defines a physical layer and a protocol stack for a 5^{th} generation (5G) of mobile networks. 5G NR operates on multiple frequency bands, allowing for wider coverage and higher data rates. It uses advanced technologies such as beamforming, massive multiple-input multiple-output (MIMO), and dynamic spectrum sharing to improve network performance and efficiency. In addition to the above, 5G NR supports new use cases such as, massive machine-type communications (mMTC) and ultra-reliable low-latency communications (URLLC), enabling deployment of new internet of things (IoT) applications and critical communication services.

Referring specifically to FIG. 1B, an environment for implementing a system for logging events in communication networks, in accordance with various embodiments of the present disclosure, is illustrated.

As shown in FIG. 1B, a system 111 for logging events in a communication network comprises a log management network function 101 and one or more network functions 102. The log management network function 101 enables logging facility for one or more events in the communication network. The log management network function 101 may be implemented in a variety of computing systems, such as, a server, a network server, a cloud-based server, and the like.

The log management network function 101 may include a processor 114, a I/O interface 115, and the memory 116. In some embodiments, the memory 116 may be communicatively coupled to the processor 114. The memory 116 stores instructions, executable by the processor 114, which, on execution, may cause the log management network function 101 to log the one or more events in the communication network, as disclosed herein.

The log management network function 101 may communicate with the one or more network functions 102 via a communication network (not explicitly illustrated in FIG. 1). In an embodiment, the communication network may include, without limitation, a direct interconnection, local area network (LAN), wide area network (WAN), controller area network (CAN), wireless network (e.g., using a wireless application protocol), the internet, and the like. In an embodiment, the log management network function 101 may comprises a network interface (not depicted) for communicating with the one or more network functions 102 via the communication network. The network interface may comprise a transceiver for transmitting/receiving signals via the communication network.

Notably, the processor 114 is configured to perform steps associated with the log management network function 101.

The log management network function 101 of the present disclosure receives a request for creating a managed object instance (MOI) of an information object class (IOC) for registering logs associated with the plurality of management services of the communication network, from the one or more network functions 102.

The term “managed object instance” (MOI) denotes a specific and distinct occurrence of a managed object within the communication network. A managed object represents a network element, resource, or entity that a network management system may monitor, configure, or control. Each managed object within the network is uniquely identified and presented as an individual instance, possessing specific attributes and parameters that may be accessed and manipulated through the network management system. The MOIs assume a critical role in enabling monitoring and management of individual network elements, providing administrators with an efficient means to track their status, performance, and configuration settings. Moreover, the term “information object class” (IOC) refers to a categorization or classification of information objects based on their common characteristics and attributes. An information object is a representation of real-world entities or concepts within a computer system or database. Information object classes group similar information objects together, sharing common properties, behaviors, and relationships. Each class defines a structure and behavior of the information objects it represents, facilitating data organization, retrieval, and manipulation. Information object classes play a fundamental role in data modeling and database design, enabling efficient data management and ensuring data consistency and integrity within the system.

The MOI of IOC refers to a specific occurrence or instantiation of an information object within the network. It represents a unique and identifiable instance of an information object class, possessing its own set of attributes and data values. The MOIs are essential for tracking and managing individual network elements, resources, and devices. Notably, the MOI of the IOC is created for registering logs associated with the plurality of management services of the communication network.

The log management network function 101 of the present disclosure creates a fragment of a network resource model (NRM) for logging events associated with the plurality of management services, based on the MOI. Herein, the NRM comprises a set of MOIs.

The NRM is an abstract representation of physical and virtual resources within a communication network, including computing devices, network equipment, bandwidth, processing power, memory, storage, and the like. The NRM may serves as a foundational framework for efficient resource management, allocation, and optimization within the network. In an embodiment, the NRM enables monitoring and controlling resources based on varying demands, facilitating provisioning, scaling, and maintenance of network resources to meet dynamic needs of communication networks. Notably, each fragment of the NRM corresponds to various activities of the communication network. The fragment of the NRM being created herein corresponds to the activity of logging in the communication network.

Further, the request may be received for a given event or for a plurality of events for which logs are to be registered. Moreover, the request may be associated with an event pertaining to a network function of the one or more network functions 102, such that each network function may send requests pertaining to events therewith.

Herein, creating the NRM fragment comprises generating a set of MOIs for logging the events related to the plurality of management services. The set of MOIs comprise an MOI for registration of a log, an MOI for information of the log, and an MOI for an entry of the log. Notably, each fragment of the NRM corresponds to various functionalities of the communication network. The fragment of the NRM being created herein corresponds to the functionality of logging within the communication network.

Each MOI of the set of MOIs comprises at least one attribute corresponding to the MOI. Further, each MOI within the set of MOIs comprises a minimum of one attribute that directly corresponds to the specific MOI. These attributes are inherently linked to and represent unique characteristics, properties, or parameters of each individual MOI within the communication network. The presence of at least one attribute dedicated to each MOI facilitates an effective capture and handling of critical information pertaining to distinct network elements or resources in the communication network. Such attribute-driven capabilities help to efficiently monitor, control, and configure the network elements, thereby contributing significantly to enhanced network performance and seamless operation.

Notably, the at least one attribute corresponding to the MOI for registration of a log comprises a maximum number of logs. When creating the NRM fragment, the set of MOIs having attributes corresponding to the events is also generated. The maximum number of logs defines a finite numeral, until such logs may be maintained by the log management network function 101. In such a case, the attribute corresponding to the MOI for registration of a log comprises a maximum capacity of logs which may be stored at the NRM fragment. For example, if the maximum number of logs is 100, only 100 logs may be created of 100 events or 100 instances of events. In order to continue logging the events, the “maximum number of logs” attribute is increased.

Further, the at least one attribute corresponding to the MOI for information of a log comprises one of: a category of a management service, or an instance of the management service. The category of the management service may refer to a classification or grouping of specific network management functionalities based on their shared characteristics and objectives. The category of the management service defines a type of management service to be logged by the IOC. The instance of the management service refers to a specific occurrence or implementation of the particular network management functionality within the communication network. The instance of the management service specifies an instant of a management service to be logged by the IOC. Notably, the category of the management service and the instance of the management service are conditional mandatory attributes, such that one of the two are complied with. In this regard, each log pertaining to the event may either comprise the category of the management service or the instance of the management service.

The at least one attribute corresponding to the MOI for information of the log further comprises at least one of, an end time, a maximum size, a current size, a log state, a log record count, and a log-full action. Herein, the end time is an attribute which defines a date and time when the log is to be stopped for logging. The maximum size is an attribute which defines the maximum number of bytes that may be utilized by a given log. The current size is an attribute which provides the number of bytes currently utilized by a given log. Moreover, an amount of space remaining in the log may be determined based on the maximum size and the current size. The log state is an attribute which provides an indication of the current state of a log. Herein, the log state may be implemented as at least one of: currently logging, log full, or logging stopped. The log record count is an attribute which defines the number of log records currently logged within a given log. The log-full action is an attribute which is defined using an enumeration. Herein, the log-full action may be implemented as one of: a wrap action or a halt action. The wrap action deletes the oldest log records based on logged time, thereby freeing resources for logging of new records. The halt action may stop logging of the log records such that entries present in the record are retained as-is, and all new log requests are cancelled.

In an embodiment, the at least one attribute corresponding to the MOI for entry of a log comprises consumer identification information, an invoked operation, a status of an operation associated with the service, an invoked NRM, an invoked notification, and performance metrics. Notably, the consumer identification information comprises data or attributes used to uniquely identify users or entities of the management service accessing a service or system. An invoked operation defines the operation invoked and the IOC(s) involved. Moreover, the invoked operation refers to an action or function called or executed by a component or user of the one or more user equipment 104, thereby triggering specific tasks or processes within the communication network. The status of an operation associated with the service denotes the current condition or state of ongoing tasks or actions related to the provided service within the communication network. The status of the operation defines whether the operation was successful or not. An invoked NRM defines the IOC(s) an operation is invoked on and designates a specific instance or component of the NRM accessed or utilized during communication network management processes. Additionally, an invoked notification defines notifications that are subscribed for, and represents a message or alert sent by any system or service to inform users or other systems about particular events or conditions within the communication network. The performance metrics encompass quantitative measurements, including response time, throughput, and error rates, utilized to assess the efficiency and effectiveness of system or service performance within the communication network. The performance metrics defines the measurements and/or key performance index (KPI) requested.

In another embodiment, the at least one attribute corresponding to the MOI for entry of a log comprises a consumer identification and information related to a component A, a component B, a component C, that may be associated with a plurality of management services of the communication network. The consumer identification is an attribute that uniquely identifies users or entities accessing a service or system, facilitating personalized interactions, and accessing control. The consumer identification identifies the consumer of the management service. Notably, the plurality of management services corresponding to the communication network comprise components A, B and C, each serving specific functions as defined in 3GPP TS 28.533. The component A indicates the operation and notification invoked for the given management service. Moreover, component A is dedicated to network monitoring and data collection, providing real-time information and statistics for network performance assessment. The component B indicates the IOC(s) accessed using a particular management service. The component B is dedicated to centralized and automated configuration management, allowing remote adjustments to network devices and resources. The component C indicates the performance metrics and KPIs requested using a particular management service. The component C is dedicated to fault management and troubleshooting, promptly detecting, and resolving network issues to maintain stability and availability. Together, these components enable effective network management, ensuring optimal performance and seamless operations. Since the plurality of management services are defined using the components A, B and C, the present disclosure utilizes a similar structure for creating logs for events corresponding to the plurality of management services.

The set of MOIs indicate a list of categories for management services to be logged, and a list of instances for the plurality of management services to be logged. Notably, for logging, either a management service itself is logged, or an instance for said management service is logged. The plurality of management services may be categorized prior to performing steps of the present disclosure to identify which management services, and which instances of any management service are to be logged. The list may be a pre-determined list, which may be determined prior to executing the method of the present disclosure.

Thereafter, the log management network function 101 of the present disclosure receives a request for accessing a management service of the plurality of management services. The log management network function 101 receives requests for accessing management services from the one or more network functions 102 of the communication network. Herein, the log management network function 101 efficiently handles incoming requests, both ensuring proper authentication and processing and allowing authorized users to interact with diverse management services. Moreover, the log management network function 101 serves as a gateway for management service access by streamlining communication and contributing to effective and secure operation of the communication network.

Further, the log management network function 101 of the present disclosure identifies whether the management service is to be logged, based on the list of categories for management services to be logged and the list of instances for the plurality of management services to be logged. Herein, the log management network function 101 identifies whether a management service is to be logged by using information from the list of categories for logged management services and the list of instances for the logged plurality of management services. The log management network function 101 cross-references the above-mentioned lists to determine if a requested management service falls within the designated categories and/or if a specific instance of the requested management service is a part of the above-mentioned lists. This ensures precise and efficient logging and capturing relevant data for effective network monitoring, troubleshooting, and performance analysis within the communication network.

Furthermore, the log management network function 101 of the present disclosure creates an entry with respect to the request for accessing the management service, using the set of MOIs, based on the identification. The log management network function 101 creates the entry concerning the request for accessing the management service by utilizing the set of MOIs, and based on the identification process. By leveraging the information obtained through identification, the log management network function 101 generates a log entry. The log entry captures relevant details of the request, such as the specific MOI associated with the accessed management service, user or entity identification information, timestamp, and other pertinent data. This log entry facilitates comprehensive tracking and documentation of management service access by enabling monitoring and analyses of system activities, detecting anomalies, and ensuring compliance with security and operational policies within the communication network.

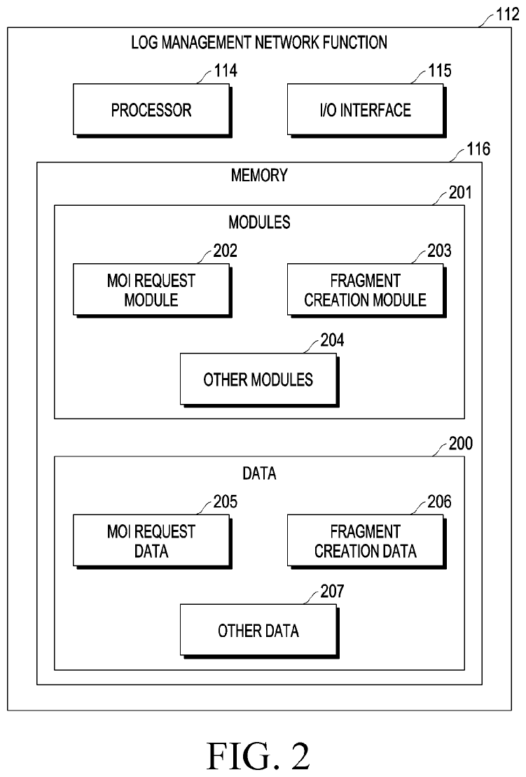

FIG. 2 illustrates a detailed diagram of a log management network function 101, in accordance with various embodiments of the present disclosure.

Data 200 and one or more modules 201 in the memory 116 of the log management network function 101 is described herein in detail.

In an embodiment, the data 200 in the memory 116 may include MOI request data 205, fragment creation data 206, and other data 207 associated with the log management network function 101.

The MOI request data 205 may include data from the network function of the one or more network functions 102. The MOI request data 205 refers to data pertaining to a request for creating the MOI of the IOC. Notably, the MOI request data 205 comprises information pertaining to the plurality of management services of the communication network.

The fragment creation data 206 may include information regarding creation of the fragment of the NRM, the set of MOIs, the IOC, and attributes associated with the set of MOIs.

The other data 207 may store data, including temporary data and temporary files, generated by the one or more modules 201 for performing the various functions of the log management network function 101.

In an embodiment, the data 200 in the memory 116 may be processed by the one or more modules 201 of the log management network function 101. The one or more modules 201 may be configured to perform the steps of the present disclosure using the data 200 for logging events in communication networks. In an embodiment, each of the one or more modules 201 may be a hardware unit which may be outside the memory 116 and coupled with the log management network function 101. In an embodiment, the one or more modules 201 may be implemented as dedicated units and when implemented in such a manner, said modules may be configured with the functionality defined in the present disclosure, resulting in a novel hardware. As used herein, the term module may refer to an application specific integrated circuit (ASIC), an electronic circuit, a field-programmable gate arrays (FPGA), programmable system-on-chip (PSoC), a combinational logic circuit, and/or other suitable components that provide the described functionality.

In one implementation, one or more modules 201 may include, but are not limited to, an MOI request module 202, a fragment creation module 203, and other modules 204, associated with the log management network function 101.

One or more modules 201 of the log management network function 101 are configured to log events in communication networks, based on the data 200. The one or more modules 201 along with the data 200 may be implemented in any communication network for logging the events.

The MOI request module 202 is configured to receive the request for creating the MOI of the IOC for registering logs associated with the plurality of management services of the communication network from a network function of the one or more network functions 102. The request may be received for a given event or for a plurality of events for which logs are to be registered. Moreover, the request may be associated with an event pertaining to the network function, such that each network function of the one or more network functions 102 may send requests pertaining to events therewith. For example, the request may pertain to editing of a document labeled “Bee180.” Herein, the request may either pertain to all instances of editing of the document (e.g., a specific management service pertaining to the document would be utilized here), or to a specific edit of the document, for example, version 4 (e.g., a specific instance of the management service).

The fragment creation module 203 is configured to create the fragment of the NRM for logging events associated with the plurality of management services. Herein, the NRM comprises a set of related MOIs. Moreover, creating the fragment comprises generating the set of MOIs for logging the events related to the plurality of management services, such that the set of MOIs comprise the MOI for registration of the log, the MOI for information of the log, and the MOI for an entry of the log. In accordance with the above example, editing of the document “Bee180” may be logged based on the specified MOIs, based on whether all instances of editing of the document are being logged, or based on whether a specific edit of the document, for example, version 4, is being logged.

Notably, each MOI of the set of MOIs comprises at least one attribute corresponding to the MOI. Further, each MOI within the set of MOIs comprises a minimum of one attribute that directly corresponds to the specific MOI. These attributes are inherently linked to and represent unique characteristics, properties, or parameters of each individual MOI within the communication network.

Notably, the at least one attribute corresponding to the MOI for registration of a log comprises a maximum number of logs, as shown below in Table 1. The fragment creation module 203, while creating the NRM fragment, generates the set of MOIs having attributes corresponding to the events. The maximum number of logs defines a finite numeral, until such logs may be maintained by the log management network function 101. In such a case, the attribute corresponding to the MOI for registration of a log comprises a maximum capacity of logs which may be stored at the NRM fragment. For example, if the maximum number of logs is 100, only 100 logs may be created of 100 events or 100 instances of events. In order to continue logging the events, the “maximum number of logs” attribute is increased.

TABLE 1

| Attribute | | | Is | Is | Is | Is | |
|---|---|---|---|---|---|---|---|
| name | S | C | Readable | Writable | Invariant | Notifyable | Description |
| maxLogs | M | 1 | T | T | F | T | This attribute defines the |
| | | | | | | | maximum number of Log |
| | | | | | | | the registry can have. |

The at least one attribute corresponding to the MOI for information of a log comprises one of: a category of a management service, or an instance of the management service, as shown below in Table 2.

TABLE 2

| | | | Is | Is | Is | Is | |
|---|---|---|---|---|---|---|---|
| Attribute name | S | C | Readable | Writable | Invariant | Notifyable | Description |
| mNSCategories | C | 1 | T | T | F | T | Type of |
| | M | | | | | | management |
| | | | | | | | service to be |
| | | | | | | | logged by LogInfo |
| | | | | | | | IOC. |
| | | | | | | | allowed Values: |
| | | | | | | | ProvMnS, |
| | | | | | | | FaultSupervision |
| | | | | | | | MnS, |
| | | | | | | | StreamingData- |
| | | | | | | | ReportingMnS, |
| | | | | | | | FileDataReporting |
| | | | | | | | MnS |
| | | | | | | | Either |
| | | | | | | | mNSCategories or |
| | | | | | | | mNSToBeLoged |
| | | | | | | | should be present. |
| mNSToBeLogged | C | 1 | T | T | F | T | It specifies the |
| | M | | | | | | specific |
| | | | | | | | management |
| | | | | | | | service to be |
| | | | | | | | logged by LogInfo |
| | | | | | | | IOC |
| | | | | | | | Either |
| | | | | | | | mNSCategories or |
| | | | | | | | mNSToBeLogged |
| | | | | | | | should be present. |
| endTime | M | 1 | T | T | F | T | Defines the date |
| | | | | | | | and time when the |
| | | | | | | | log should stops |
| | | | | | | | logging. |
| maxSize | M | 1 | T | T | F | T | This attribute |
| | | | | | | | defines the |
| | | | | | | | maximum number |
| | | | | | | | of bytes that may |
| | | | | | | | be utilized by a |
| | | | | | | | given log, |
| | | | | | | | assigned by the |
| | | | | | | | IRPAgent. |
| currentSize | M | 1 | T | T | F | T | This attribute |
| | | | | | | | provides the |
| | | | | | | | number of bytes |
| | | | | | | | currently utilized |
| | | | | | | | by a given log. |
| | | | | | | | When taken in |
| | | | | | | | conjunction with |
| | | | | | | | maxSize, the |
| | | | | | | | amount of space |
| | | | | | | | remaining in the |
| | | | | | | | log can be |
| | | | | | | | determined. |
| logState | M | 1 | T | T | F | T | Provides an |
| | | | | | | | indication of the |
| | | | | | | | current state of a |
| | | | | | | | specific log |
| | | | | | | | An ENUM that |
| | | | | | | | can have one of |
| | | | | | | | the following |
| | | | | | | | values: logging, |
| | | | | | | | logFull and |
| | | | | | | | stopped |
| logRecordCount | M | 1 | T | T | F | T | The number of log |
| | | | | | | | records currently |
| | | | | | | | logged within a |
| | | | | | | | given log. |
| logFullAction | M | 1 | T | T | F | T | An ENUM that |
| | | | | | | | can have one of |
| | | | | | | | the following |
| | | | | | | | values: |
| | | | | | | | wrap: The oldest |
| | | | | | | | LogRecord(s) in |
| | | | | | | | the Log, based on |
| | | | | | | | the log time, will |
| | | | | | | | be deleted to free |
| | | | | | | | resources for the |
| | | | | | | | logging of new |
| | | | | | | | LogRecord(s). |
| | | | | | | | halt: No more |
| | | | | | | | LogRecord(s) will |
| | | | | | | | be logged and all |
| | | | | | | | incoming events |
| | | | | | | | are discarded. |
| | | | | | | | LogRecord/s |
| | | | | | | | already in the Log |
| | | | | | | | will be retained. |

The at least one attribute corresponding to the MOI for information of the log further comprises at least one of an end time, a maximum size, a current size, a log state, a log record count, and a log-full action, as shown above in Table 2.

In an embodiment, the at least one attribute corresponding to the MOI for entry of a log comprises consumer identification information, an invoked operation, a status of an operation associated with the service, an invoked NRM, an invoked notification, and performance metrics, as shown below in Table 3.

TABLE 3

| | | | Is | Is | Is | Is | |
|---|---|---|---|---|---|---|---|
| Attribute name | S | C | Readable | Writable | Invariant | Notifyable | Description |
| consumer- | M | 1 . . . * | T | T | F | T | This identifies the |
| Identification | | | | | | | consumer of the |
| | | | | | | | management service. |
| operation- | M | 1 . . . * | T | T | F | T | This defines the |
| Invoked | | | | | | | operation invoked |
| | | | | | | | and the IOC(s) |
| | | | | | | | involved. |
| >status | M | 1 | T | T | F | T | This defined if the |
| | | | | | | | operation was |
| | | | | | | | successful or not. |
| | | | | | | | ENUM (SUCCESS, |
| | | | | | | | FALIURE) |
| >nrmInvoked | M | 1 | T | T | F | T | This defines the |
| | | | | | | | IOC(S) the operation |
| | | | | | | | was invoked on. |
| notification- | M | 1 . . . * | T | T | F | T | This defines the |
| Invoked | | | | | | | notifications that are |
| | | | | | | | subscribed for. |
| performance | O | 0 . . . * | T | T | F | T | This defines the |
| Metric- | | | | | | | measurements and/or |
| Collected | | | | | | | KPI requested |

In another embodiment, the at least one attribute corresponding to the MOI for entry of a log comprises a consumer identification, and information related to a component A, a component B, a component C, associated with the plurality of management services of the communication network, as shown below in Table 4.

TABLE 4

| | | | Is | Is | Is | Is | |
|---|---|---|---|---|---|---|---|
| Attribute name | S | C | Readable | Writable | Invariant | Notifyable | Description |
| consumer- | M | 1 . . . * | T | T | F | T | This identifies the |
| Identification | | | | | | | consumer of the |
| | | | | | | | management service. |
| compA | M | 1 . . . * | T | T | F | T | This indicates the |
| | | | | | | | operation and |
| | | | | | | | notification invoked for |
| | | | | | | | the given management |
| | | | | | | | service |
| compB | M | 1 . . . * | T | T | F | T | This indicates the |
| | | | | | | | IOC(s) accessed using a |
| | | | | | | | particular management |
| | | | | | | | service |
| compC | M | 1 . . . * | T | T | F | T | This indicates the |
| | | | | | | | performance metrics |
| | | | | | | | and KPIs requested |
| | | | | | | | using a particular |
| | | | | | | | management service |

The one or more modules 201 may also include other modules 204 to perform various miscellaneous functionalities of the log management network function 101. It will be appreciated that the one or more modules 201 may be represented as a single module or a combination of different modules.

In an embodiment, the other modules 204 may include an access request module, a management service identification module, and an entry creation module. The access request module may be configured to receive the request for accessing the management service of the plurality of management services. The management service identification module may be configured to identify whether the management service is to be logged, based on the list of categories for management services to be logged and the list of instances for the plurality of management services to be logged. The entry creation module may be configured to create the entry with respect to the request for accessing the management service, using the set of MOIs, based on the identification performed by the management service identification module.

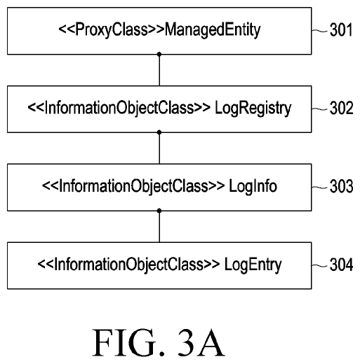

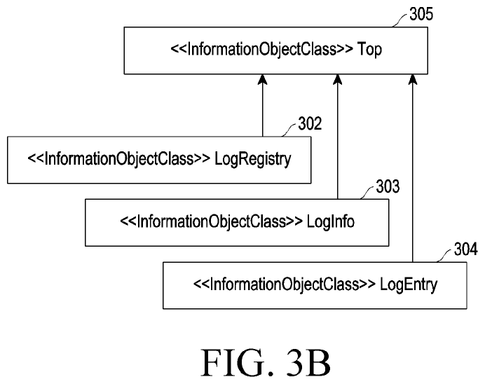

FIG. 3A and FIG. 3B illustrate relationships between information object classes (IOCs) of a set of managed object instances (MOIs) for logging events in communication networks, in accordance with an embodiment of the present disclosure.

Referring specifically to FIG. 3A, relationship between the information object classes (IOCs) of the set of managed object instances (MOIs) of the fragment of the network resource model (NRM) for logging events in communication networks is illustrated.

Notably, the set of MOIs comprises an MOI for registration of a log, an MOI for information of the log, and an MOI for an entry of the log. Herein, the MOI for registration of a log corresponds with the IOC LogRegistry 302, the MOI for information of the log corresponds with the IOC LogInfo 303, and the MOI for an entry of the log corresponds with the IOC LogEntry 304.

As shown in FIG. 3A, on creation of the fragment of the NRM, a ProxyClass for a managed entity (ME) 301 is created. The ME 301 includes a composition relationship with the IOC LogRegistry 302, the IOC LogInfo 303, and the IOC LogEntry 304. Therefore, on creation of the ME 301, the IOC LogRegistry 302, the IOC LogInfo 303, and the IOC LogEntry 304 are also created.

Referring now specifically to FIG. 3B, an inheritance relationship between the information object classes (IOCs) of the set of managed object instances (MOIs) for logging events in communication networks is illustrated.

As shown in FIG. 3B, an IOC top 305 inherits information or attributes pertaining to the IOC LogRegistry 302, the IOC LogInfo 303, and the IOC LogEntry 304. Since the inheritance relationship is an “is-a” relationship, the IOC top 305 is a cumulation of the IOC LogRegistry 302, the IOC LogInfo 303, and the IOC LogEntry 304.

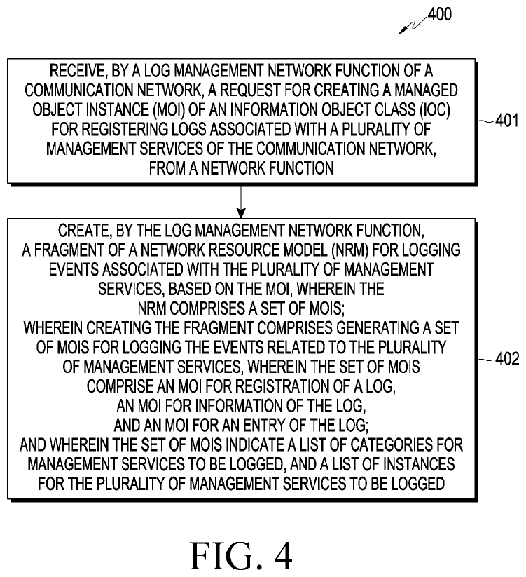

FIG. 4 illustrates a flow chart of method steps of logging events in communication networks, in accordance with various embodiments of the present disclosure.

As illustrated in FIG. 4, method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which method 400 is described is not intended to be construed as a limitation, and any number of the described method blocks can be combined in any order to implement the method. Additionally, individual blocks may be deleted from the method without departing from the scope of the subject matter described herein. Furthermore, the method can be implemented in any suitable hardware, software, firmware, or combination thereof.

At step 401, the method comprises receiving the request for creating the MOI of the IOC for registering logs associated with the plurality of management services of the communication network from the network function of the one or more network functions 102. The request may be received for a given event or for a plurality of events for which logs are to be registered. Moreover, the request may be associated with an event pertaining to the network function, such that each network function may send requests pertaining to events therewith.

At step 402, the method comprises creating the fragment of the NRM for logging events associated with the plurality of management services, based on the MOI. The NRM comprises a set of related MOIs. Notably, each fragment of the NRM corresponds to various functionalities of the communication network. The fragment of the NRM being created herein corresponds to the functionality of logging within the communication network.

Herein, creating the fragment comprises generating a set of MOIs for logging the events related to the plurality of management services. The set of MOIs comprise an MOI for registration of a log, an MOI for information of the log, and an MOI for an entry of the log. The step of creating the fragment therewith comprises generating the set of MOIs. Notably, each MOI of the set of MOIs comprises at least one attribute corresponding to the MOI. It will be appreciated that each event in the communication network include attributes which may be mapped to the at least one attribute corresponding to the MOI. Each MOI of the set of MOIs comprises attributes, which provide information pertaining to the event being logged.

Moreover, the set of MOIs indicate a list of categories for management services to be logged, and a list of instances for the plurality of management services to be logged. Notably, for logging, either a management service itself is logged, or an instance for said management service is logged. Management services may be categorised prior to performing steps of the present method to identify which management services, and which instances of any management service are to be logged.

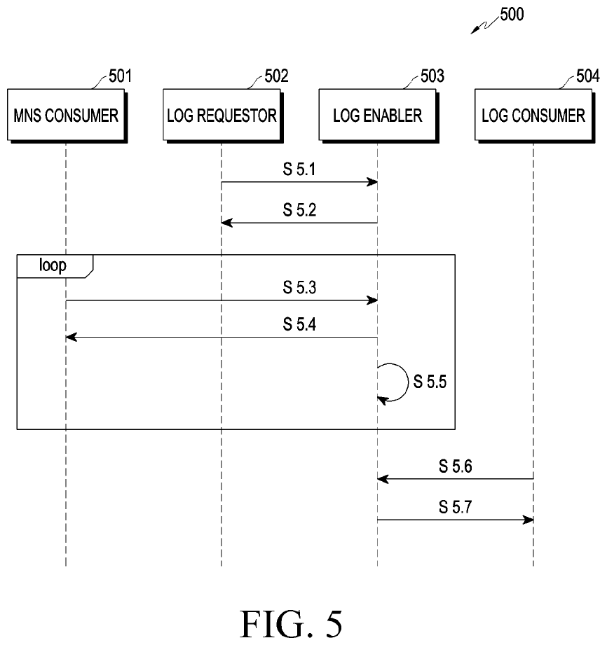

FIG. 5 illustrates a sequence diagram of steps for logging events in communication networks, in accordance with various embodiments of the present disclosure.

As illustrated in FIG. 5, the sequence diagram 500 may comprise one or more steps. The sequence diagram 500 may be described in the general context of computer executable instructions. Generally, computer executable instructions can include routines, programs, objects, components, data structures, procedures, modules, and functions, which perform particular functions or implement particular abstract data types.

As shown in FIG. 5, the steps for logging events in communication networks are performed by a plurality of entities, including, but not limited to, a management service (MnS) consumer 501, a log requestor 502, a log enabler 503, and a log consumer 504. Notably, the MnS consumer 501, the log requestor 502, and the log consumer 504 may be implemented as the one or more network functions 102 and the log enabler 503 may be implemented as the log management network function 101. Herein, the MnS consumer 501 refers to an entity which is consuming a management service. The log requestor 502 refers to an entity which is requesting a log pertaining to the management service. The log requestor 502 may be implemented as a provisioning MnS consumer since it is provisioning logging of the management service. The log enabler 503 refers to an entity which enables logging of the management service. The log enabler 503 may be implemented as an MnS producer since it creates the log pertaining to the management service. The log consumer 504 refers to an entity which consumes the log pertaining to the management service.

At step S5.1, the log requestor 502 sends a request to the log enabler 503 to create the MOI for registering logs. The log enabler 503 creates the MOI and confirms the same to the log requestor 502 at step S5.2.

Thereafter, on every MnS access, the MnS consumer 501 sends an MnS access request to the log enabler 503 at step S5.3 and receives an MnS access response from the log enabler 503 at step S5.4.

At step S5.5, the log enabler 503 checks available logs and creates a log entry for said MnS access. Notably, steps S5.3, S5.4 and S5.5 are repeated in loop for each MnS access.

Furthermore, at step S5.6, the log consumer 504 sends a request to the log enabler 503 to fetch MOI attributes, and at step S5.7, the log enabler 503 responds to the log consumer 504 with the MOI attributes.

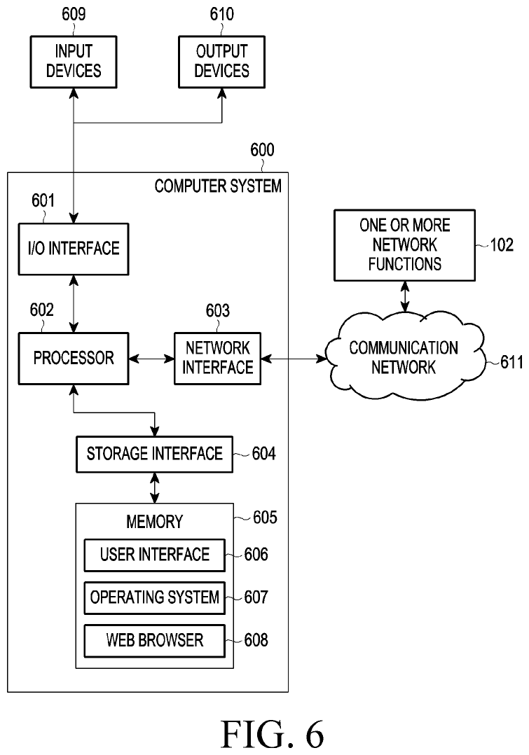

FIG. 6 illustrates a block diagram of a computer system for implementing various embodiments of the present disclosure.

In an embodiment, the computer system 600 is used to implement the system 111 for logging events in communication networks. The computer system 600 may include a central processing unit (“CPU” or “processor”) 602. The processor 602 may include at least one data processor for executing processes in virtual storage area network. The processor 602 may include specialized processing units such as, integrated system (bus) controllers, memory management control units, floating point units, graphics processing units, digital signal processing units, etc.

The processor 602 may be disposed in communication with one or more input/output (I/O) devices 609 and 610 via I/O interface 601. The I/O interface 601 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices 609 and 610. For example, the input devices 609 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 610 may be a printer, fax machine, video display (e.g., cathode ray tube (CRT), liquid crystal display (LCD), light-emitting diode (LED), plasma, plasma display panel (PDP), organic light-emitting diode display (OLED) or the like), audio speaker, etc.

In some embodiments, the computer system 600 may consist of the log management network function 101 for logging events in communication networks. The processor 602 may be disposed in communication with the communication network 611 via a network interface 603. The network interface 603 may communicate with the communication network 611. The network interface 603 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 611 may include, without limitation, a direct interconnection, local area network (LAN), wide area network (WAN), wireless network (e.g., using wireless application protocol), the internet, etc. Using the network interface 603 and the communication network 611, the computer system 600 may communicate with the one or more network functions 102 for logging events in communication networks. The network interface 603 may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 611 includes, but is not limited to, a direct interconnection, an e-commerce network, a peer to peer (P2P) network, local area network (LAN), wide area network (WAN), wireless network (e.g., using wireless application protocol), the internet, Wi-Fi, and such. The first network and the second network may either be a dedicated network or a shared network, which represents an association of the different types of networks that use a variety of protocols, for example, hypertext transfer protocol (HTTP), transmission control protocol/internet protocol (TCP/IP), wireless application protocol (WAP), etc., to communicate with each other. Further, the first network and the second network may include a variety of network devices, including routers, bridges, servers, computing devices, storage devices, etc.

In some embodiments, the processor 602 may be disposed in communication with a memory 605 (e.g., RAM, ROM, etc., not shown in FIG. 6) via a storage interface 604. The storage interface 604 may connect to memory 605 including, without limitation, memory drives, removable disc drives, etc., employing connection protocols such as, serial advanced technology attachment (SATA), integrated drive electronics (IDE), IEEE-1394, universal serial bus (USB), fibre channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 605 may store a collection of program or database components, including, without limitation, user interface 606, an operating system 607, etc. In some embodiments, computer system 600 may store user/application data, such as, the data, variables, records, etc., as described herein. Such databases may be implemented as fault-tolerant, relational, scalable, secure databases such as Oracle® or Sybase®.

The operating system 607 may facilitate resource management and operation of the computer system 600. Examples of operating systems include, without limitation, APPLE MACINTOSH® OS X, UNIX®, UNIX-like system distributions (e.g., BERKELEY SOFTWARE DISTRIBUTION™ (BSD), FREEBSD™, NETBSD™, OPENBSD™, etc.), LINUX DISTRIBUTIONS™ (e.g., RED HAT™, UBUNTU™, KUBUNTU™, etc.), IBM™ OS/2, MICROSOFT™ WINDOWS™ (XP™, VISTA™/7/8, 10, etc.), APPLE® IOS™, GOOGLE® ANDROID™, BLACKBERRY® OS, or the like.

In some embodiments, the computer system 600 may implement a web browser stored program component 608. The web browser 608 may be a hypertext viewing application, such as Microsoft Internet Explorer, Google Chrome, Mozilla Firefox, Apple Safari, etc. Secure web browsing may be provided using hypertext transport protocol secure (HTTPS), secure sockets layer (SSL), transport layer security (TLS), etc. The web browser 608 may utilize facilities such as AJAX, DHTML, Adobe Flash, JavaScript, Java, application programming interfaces (APIs), etc. In some embodiments, the computer system 600 may implement a mail server stored program component. The mail server may be an internet mail server such as Microsoft Exchange, or the like. The mail server may utilize facilities such as ASP, ActiveX, ANSI C++/C #, Microsoft .NET, common gateway interface (CGI) scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 600 may implement a mail client stored program component. The mail client may be a mail viewing application, such as Apple Mail, Microsoft Entourage, Microsoft Outlook, Mozilla Thunderbird, etc.

The method and the system for logging events in communication networks as disclosed in the present disclosure have several inherent advantages.

In an embodiment, the present disclosure facilitates logging functionality in communication networks, for logging management services or instances thereof.

In an embodiment, the present disclosure provides effective control and generation of logs for consumed management services associated with the communication network.

In an embodiment, the present disclosure improves time and resource usage efficiency while resolving issues within the communication network, since all events are properly logged. As such, overall efficiency of the communication network may be improved.

In an embodiment, the present disclosure significantly enhances network troubleshooting capabilities, enabling prompt root cause analysis and efficient problem resolution.

In an embodiment, the present disclosure improves overall network management efficiency, ensuring superior service delivery and optimized network performance.

Furthermore, one or more computer-readable storage media may be utilized in implementing various embodiments of the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the various embodiments described herein. The term “computer-readable medium” should be understood to include tangible items and exclude carrier waves and transient signals (i.e., be non-transitory). Examples include random access memory (RAM), read-only memory (ROM), volatile memory, non-volatile memory, hard drives, CD ROMs, DVDs, flash drives, disks, and any other known physical storage media.

A description of an embodiment with several components in communication with each other does not imply that all such components are required. On the contrary, a variety of optional components are described to illustrate the wide variety of possible embodiments of the present disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or articles. The functionality and/or the features of a device may be alternatively embodied by one or more other devices which are not explicitly described as having such functionality/features. Thus, other embodiments of the present disclosure need not include the device itself.

The illustrated operations of FIGS. 4 and 5 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the present disclosure be limited not by this detailed description, but rather by any claims that issue on an application based hereon. Accordingly, the various embodiments described herein are intended to be illustrative, but not limiting, of the scope of the claimed invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of logging events in a communication system, the method comprising:
receiving, by a log management network function of a communication network, a request for creating a managed object instance (MOI) of an information object class (IOC) for registering logs associated with a plurality of management services of the communication network, from a network function; and
creating, by the log management network function, a fragment of a network resource model (NRM) for logging events associated with the plurality of management services, based on the MOI, wherein the NRM comprises a set of MOIs;
wherein creating the fragment comprises generating the set of MOIs for logging the events associated to the plurality of management services, wherein the set of MOIs comprise an MOI for registration of a log, an MOI for information of the log, and an MOI for an entry of the log; and
wherein the set of MOIs indicate a list of categories for the plurality of management services to be logged, and a list of instances for the plurality of management services to be logged.

2. The method of claim 1, further comprising:
receiving, by the log management network function, a request for accessing a management service of the plurality of management services;
identifying, by the log management network function, whether the management service is to be logged, based on the list of categories for the plurality of management services to be logged and the list of instances for the plurality of management services to be logged; and
creating, by the log management network function, an entry with respect to the request for accessing the management service, using the set of MOIs, based on the identification.

3. The method of claim 1, wherein each MOI of the set of MOIs comprises at least one attribute corresponding to the MOI for registration of the log, the MOI for information of the log, the MOI for an entry of the log, respectively.

4. The method of claim 3, wherein the at least one attribute corresponding to the MOI for registration of the log comprises a maximum number of logs.

5. The method of claim 3, wherein the at least one attribute corresponding to the MOI for information of the log comprises one of: a category of a management service, or an instance of the management service.

6. The method of claim 3, wherein the at least one attribute corresponding to the MOI for entry of the log comprises consumer identification information, an invoked operation, a status of an operation associated with a management service, an invoked NRM, an invoked notification, and performance metrics.

7. The method of claim 3, wherein the at least one attribute corresponding to the MOI for entry of the log comprises a consumer identification and information related to a component A, a component B, a component C associated with the plurality of management services of the communication network.

8. A network entity including a log management network function for logging events in a communication system, comprising:
a network interface; and
a processor configured to:
receive, via the network interface, a request for creating a managed object instance (MOI) of an information object class (IOC) for registering logs associated with a plurality of management services of a communication network, from a network function; and
create a fragment of a network resource model (NRM) for logging events associated with the plurality of management services, based on the MOI, wherein the NRM comprises a set of MOIs;
wherein creating the fragment comprises generating the set MOIs for logging the events related to the plurality of management services, wherein the set of MOIs comprise an MOI for registration of a log, an MOI for information of the log, and an MOI for an entry of the log; and
wherein the set of MOIs indicate a list of categories for the plurality of management services to be logged, and a list of instances for the plurality of management services to be logged.

9. The network entity of claim 8, wherein the processor is configured to:
receive a request for accessing a management service of the plurality of management services;
identify whether the management service is to be logged, based on the list of categories for the plurality of management services to be logged and the list of instances for the plurality of management services to be logged; and
create an entry with respect to the request for accessing the management service, using the set of MOIs, based on the identification.

10. The network entity of claim 8, wherein each MOI of the set of MOIs comprises at least one attribute corresponding to the MOI for registration of the log, the MOI for information of the log, the MOI for an entry of the log, respectively.

11. The network entity of claim 10, wherein the at least one attribute corresponding to the MOI for registration of the log comprises a maximum number of logs.

12. The network entity of claim 10, wherein the at least one attribute corresponding to the MOI for information of the log comprises one of: a category of a management service, or an instance of the management service.

13. The network entity of claim 10, wherein the at least one attribute corresponding to the MOI for entry of the log comprises consumer identification information, an invoked operation, a status of an operation associated with a management service, an invoked NRM, an invoked notification, and performance metrics.

14. The network entity of claim 10, wherein the at least one attribute corresponding to the MOI for entry of the log comprises a consumer identification and information related to a component A, a component B, a component C associated with the plurality of management services of the communication network.
